(19) United States
(12) Patent Application Publication
(10) Pub. No.: US 2009/0064256 A1
(43) Pub. Date: Mar. 5, 2009

(54) EFFICIENT SELECTION OF AUXILIARY BROADCAST-SERVICE DATA ACCORDING TO A USER PREFERENCE

(75) Inventors: Prashant Vardhan Agarwal, Bareilly (IN); Bhargavi Upadhya, Bangalore (IN); Kiran S. Mirle, Bangalore (IN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/293,439

(22) PCT Filed: Mar. 20, 2007
(86) PCT No.: PCT/IB2007/050966

§ 371 Date: Sep. 18, 2008

(30) Foreign Application Priority Data
Mar. 24, 2006 (EP) 06111678.6

(51) Int. Cl. H04N 7/173

(52) U.S. Cl. 725/118

(57) ABSTRACT

A system for distribution of data comprising: a transmitting device (100) arranged to transmit data comprising plurality of services, each service being transmitted on one of a plurality of channels (210, 220, 230, etc.); a plurality of receiving devices (110, 120, 130, etc.) arranged to receive said data and to select a service from the plurality of services, characterized by: the receiving device (110) being arranged to receive auxiliary data (340) comprising information (310 and 320) about the service and an identification of one channel from said plurality of channels (330 or 335) on which said service is transmitted; the receiving device (110) being arranged to change to the channel according to the auxiliary data (340) to receive the desired service corresponding to said channel. Also the methods of transmitting and receiving the distributed data.

The invention relates to a system for distribution of data from a transmitting device to plurality of receiving devices.

Contemporary broadcast networks move quickly from analog TV broadcast to digital TV broadcast. The digital TV broadcast offers more broadcast channels in the same amount of bandwidth than analog TV and additionally allows receiving high-definition programming. The more efficient use of the bandwidth is realized by multiplexing of various broadcast channels in the available broadcast bandwidth.

US patent application US005418782A discloses methods and apparatus for providing virtual service selection in a multi-service communications system wherein the service components of each of a number of basic services are transmitted to subscriber locations on one of a plurality different frequency channels. A virtual service definition specifies which of the service components carried on a particular frequency channel comprise that service, and is periodically transmitted to each subscriber location on the frequency channel carrying the service components that comprise that basic service. When a service is selected by a subscriber, a decoder at the subscriber location tunes to the frequency channel carrying the service components of the selected service, extracts the virtual service definition for the selected service, and then obtains from the frequency channel the service components specified in the extracted virtual service definition.

A disadvantage of the above method and apparatus is that they are relatively slow as it can be time consuming to find a first service component presence.

It is an object of the invention to provide a system of the kind set forth, in which the time to locate a service component is reduced.

This object is achieved according to invention in a system as stated above, characterized by

the receiving device being arranged to receive auxiliary data comprising information about the service and an identification of one channel from said plurality of channels on which said service is transmitted, and the receiving device being arranged to change to the channel according to the auxiliary data to receive the desired service corresponding to said channel. After receiving the auxiliary data, the receiving device can tune/change faster to the channel, whose channel identification is comprised in the auxiliary data, on which the desired service is transmitted. This way of tuning/changing to the channel on which the service is present and receiving this service takes less time than in case of scanning the channels for the service presence.

In an embodiment, the auxiliary data comprises language information about the language, in which said service being transmitted is provided. This enables the receiving device to operate intelligently by selecting services based on the language used by these services. For example, the receiving device can acquire services in the user-preferred language.

In another embodiment, the receiving device is arranged to change automatically to the channel, according to the auxiliary data, on which the desired services provided in the user pre-set language in the receiving device are transmitted, and to receive said services provided in said user pre-set language.

Such automatic changing to the appropriate channels and receiving of services in the pre-set user language is user-friendly, as no user interaction is required. The user needs only to pre-set the language, which he/she does at the installation of the receiving device.

In another embodiment, the auxiliary data comprises a version number of the said service being transmitted. This enables the receiving device to operate based on the version of these services. Many operations are now possible. As an example, such auxiliary data enables making selective service updates, which means that the user can benefit from the updated services in a short time.

The invention further provides a transmitting device and a receiving device for use in the system according to the invention, as well as corresponding methods.

These and other aspects of the invention will be apparent from and elucidated with reference to the embodiments shown in the drawings, in which:

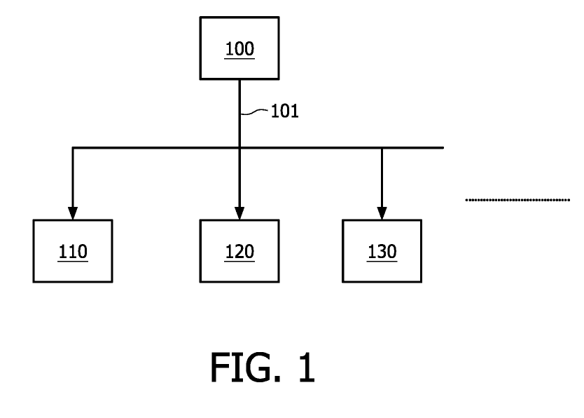

FIG. 1 schematically shows a data distribution system consisting of a transmitting device arranged to transmit data and a plurality of receiving devices arranged to receive said data;

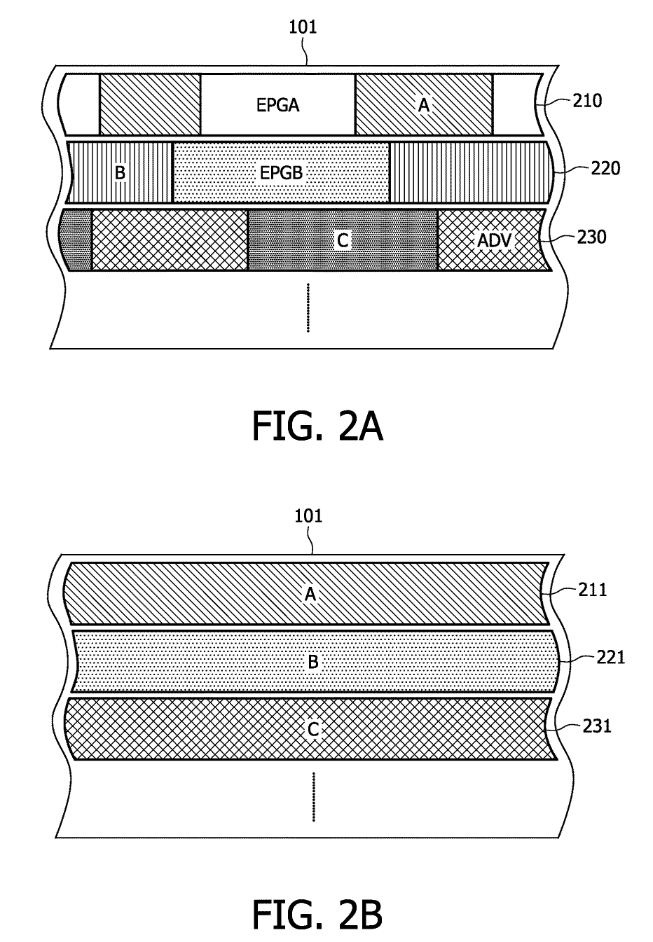

FIG. 2A illustrates a plurality of services on a plurality of channels characteristic for a digital TV system; each service being transmitted on one of a plurality of channels;

FIG. 2B shows services and channels in an analog TV system;

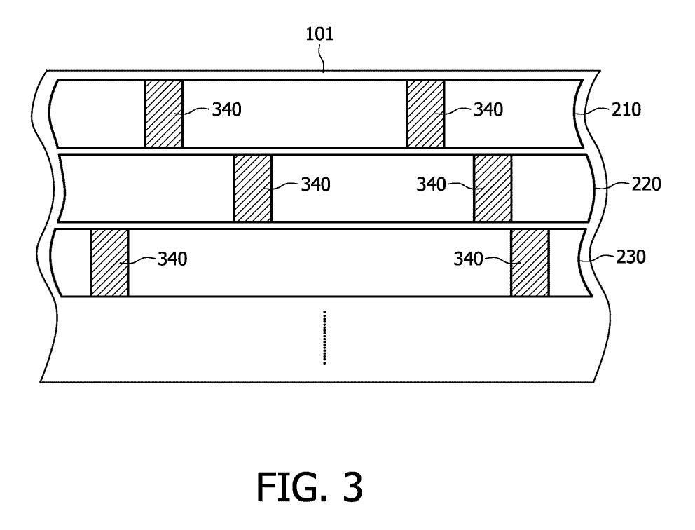

FIG. 3 shows multiplexing of auxiliary data with services in data streams transmitted on a plurality of channels;

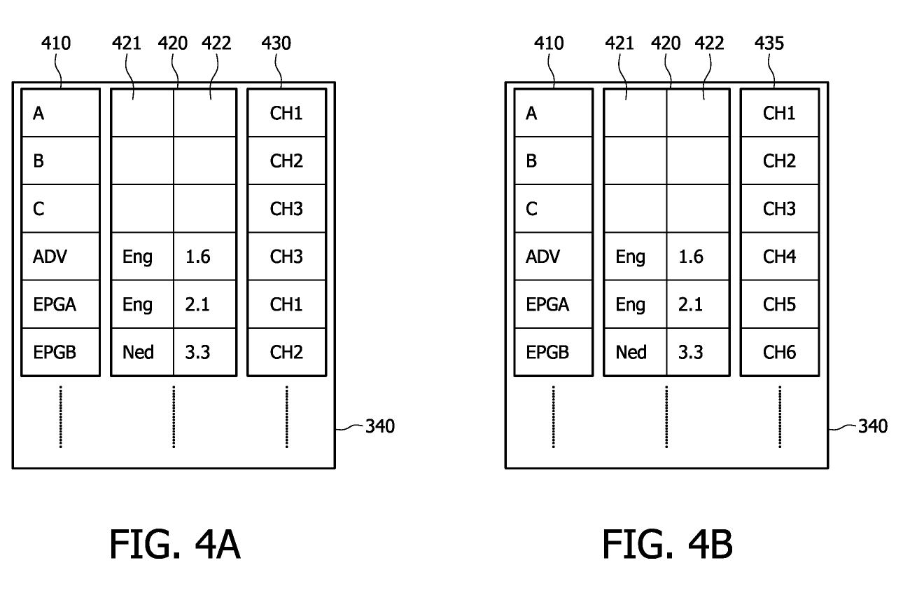

FIG. 4A illustrates an example format of auxiliary data specified for a digital TV system;

FIG. 4B illustrates an example format of auxiliary data specified for an analog TV system;

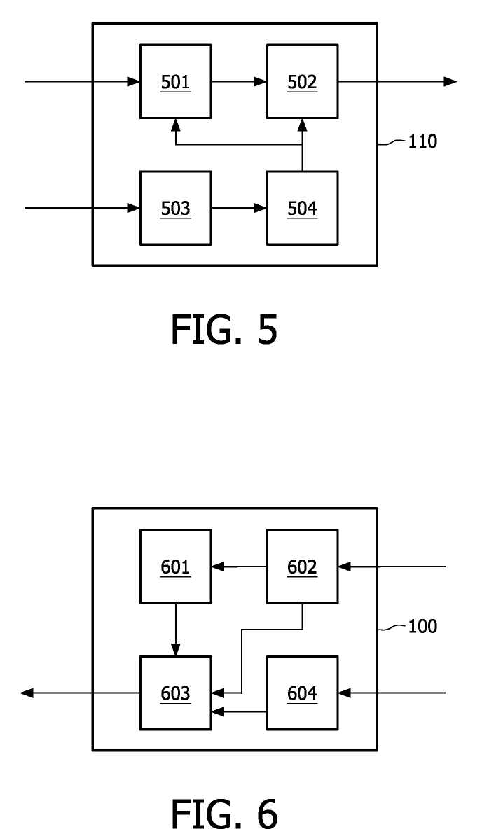

FIG. 5 shows an example of an internal architecture of a receiving device;

FIG. 6 shows an example of an internal architecture of a transmitting device;

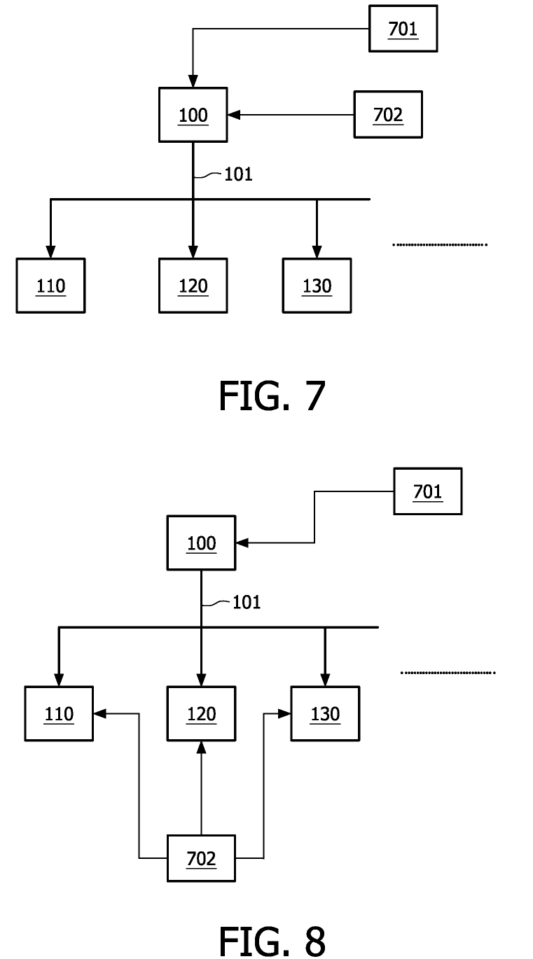

FIG. 7 illustrates an alternative architecture of a data distribution system, in which auxiliary data is provided to a transmitting device from a separate device independent from a service data;

FIG. 8 illustrates an alternative architecture of a data distribution system, in which auxiliary data is provided to a receiving device from a separate device independent from a device transmitting the service data.

Throughout the figures, same reference numerals indicate similar or corresponding features. Some of the features indicated in the drawings are typically implemented in software, and as such represent software entities, such as software modules or objects.

FIG. 1 schematically shows a data distribution system comprising a transmitting device 100 arranged to transmit data 101 and a plurality of receiving devices 110, 120, 130, etc., arranged to receive said data. The distribution system is a broadcast system, i.e. transmitted data 101 reaches every receiving device in this data distribution system. It is up to the receiving device 110 whether any of data offered by a transmitting device 100 to all receiving devices will be actually used by this receiving device 110.

The type of transmission medium for the data transmission 101 depends on a technology used for the data distribution. Examples of such technologies are: satellite networks, cable networks, terrestrial networks, or telephone networks. Each of these technologies determines a type and characteristics of the transmitting device 100 and the receiving device 110. For example, for satellite networks the transmitting device 100 is a satellite transmitter, while the receiving device 110 is a satellite receiver. For cable networks, the transmitting device 100 is a head-end, while the receiving device 110 is a cable modem or a set-top-box. Note that the transmission may take place using multiple types of technologies in sequence. For example, data may be transmitted by cable from the original transmitter to a satellite uplink station, from there be transmitted by satellite network to a redistribution station which transmits the data to a multitude of head-end devices. The head-ends then redistribute the data to cable modems.

Various types of the receiving device 110 are possible. The receiving device 110 can be e.g. a television set, a VCR, a DVD recorder, a set-top box, a PC, a portable TV receiver, an audio receiver, and a portable audio receiver.

In an alternative embodiment the distribution system is one-to-one, multicast or peer-to-peer redistribution. In all these embodiments one may receive multiple services multiplexed into a signal, from which a selection is to be made.

FIG. 2A illustrates a plurality of services A, B, C, EPGA, EPGB, ADV, etc. on a plurality of channels 210, 220, 230, etc. characteristic for a digital TV system; each service being transmitted on one of a plurality of channels. In this figure the data transmission 101 from the transmitting device 100 is shown. The data transmission 101 is organized in a plurality of channels 210, 220, 230, etc., which correspond to frequencies. This means that the transmitting device 100 transmits simultaneously data on different channels 210, 220, 230, etc. On each channel data corresponding to a plurality of services is transmitted by means of data multiplexing. For the channel 210 the services A and EPGA are transmitted by means of data multiplexing. For the channel 220 the services B and EPGB are transmitted by means of data multiplexing. For the channel 230 the services C and ADV are transmitted by means of data multiplexing.

A service means here a broadcast program such as e.g. BBC World, Discovery Channel, CNN, etc. Service multiplexing is illustrated in the Fig. by means of different fill patterns that are used to indicate data portions belonging to different services. Data blocks with the same patterns belong to the same service. Furthermore, a service resides entirely on one channel. In other words, in FIG. 2A a service is transmitted on a single frequency.

FIG. 2B shows services and channels in an analog TV system. As in case of the digital TV system shown in FIG. 2A the data transmission 101 is organized in a plurality of channels 211, 221, 231, etc. However, in the analog TV system only one service is transmitted on a single channel. This is illustrated in FIG. 2B by using only one pattern for data transmitted on a single channel, for example services A, B, C are transmitted on the channels 211, 221, 231, respectively.

Examples of services provided in the data distribution system, both the digital and analog TV systems, are among others: television or movie broadcast, video-on-demand, interactive TV, audio broadcast, EPG, news, advertisements, games, remote programming, software updates, etc. Some of these services require real-time transmission, for example, these related to streaming of live video and live audio. Such services have specific timing constraints imposed on a data delivery. Other services that are not real-time do not have timing restrictions, and are regularly offered to receiving devices 110, 120, 130, etc. through a bulk data transmission to a user by means of a so-called carousel. The carousel means here repetitive and (nearly) periodical re-transmission of a specific service.

In a preferred embodiment the data comprising the services and the auxiliary data 340 are comprised in a combined data. FIG. 3 shows multiplexing of auxiliary data 340 with services in data streams transmitted on plurality of channels 210, 220, 230, etc. Combining of services with the auxiliary information 340 is realized through multiplexing them together on a channel, e.g. 210, on which they are transmitted. Such service and auxiliary data 340 multiplexing is required for a case of an architecture presented in FIG. 7. FIG. 3 shows data streams on multiple channels 210, 220, 230, etc. In each of these channels the auxiliary data 340, indicated by the hashed data blocks, is inserted in-between data streams corresponding to services, which are represented by blank data blocks in the figure.

The auxiliary data 340 can be sent either as one block of data or could be fragmented. Fragmentation could be required in case the auxiliary data 340 transmission could jeopardize the timely transmission of real-time services.

The auxiliary data 340, depicted in FIG. 3, is transmitted regularly on each of the plurality of channels. A period of auxiliary data transmission can vary per channel, as shown in the figure for the two data streams corresponding to the channels 210 and 230, respectively. Auxiliary data 340 is transmitted periodically or nearly periodically, so that the real-time service delivery is not disturbed.

FIG. 4A illustrates an example format of auxiliary data 340 specified for a digital TV system. The auxiliary data 340 is in FIG. 4A presented in a form of a table. A single row in this table corresponds to a single service. Three services A, B and C are shown, which correspond to the services shown in FIG. 2A. A parameter in a first column 410 comprises a name or a publicly known identifier of the service. A parameter in a third column 430 comprises a publicly known channel identifier, e.g. CH1, which using e.g. a look-up table can be translated into an actual channel, e.g. 210, on which the specific service is transmitted. Alternatively, a specific frequency value could be used in the third column 430. An entry in a second column 420 comprises a service description, which can consist of multiplicity of parameters characterizing the service.

Two examples of such parameters are a language 421 in which the service is provided, and a version number 422 of the current service. However, these parameters are only examples and other parameters are also possible.

The services A and EPGA are, all together, transmitted on a channel CH1 corresponding to 210 in FIG. 2A, while the services B and EPGB are transmitted on a channel CH2 corresponding to 220, and the services C and ADV are transmitted on a channel CH3 corresponding to 230.

FIG. 4B illustrates an example format of auxiliary data specified for an analog TV system. The example largely corresponds to the example of FIG. 4A. Because FIG. 4B illustrates the analog TV system, now each of services shown in this figure has a different channel assigned to it, as indicated in a third column 435 corresponding to a channel on which transmission of the service is performed.

For the tables shown in FIGS. 4A and 4B a number of services captured in the auxiliary data 340 can vary. It is, however, beneficial to create an auxiliary data that covers the whole range of services transmitted on all channels 210, 220, 230, etc. (in case of the digital TV system) available to the receiving devices 110, 120, 130, etc. listening/tuned to the transmitting device 100. The advantage of such cumulative character of the auxiliary data 340 is that the receiving devices 110, 120, 130, etc. listening/being tuned to one of the channels 210, 220, 230, etc. can acquire from this channel information about all services available on all channels. Therefore, when required, allowing focused, thus quick, change to the new channel (being one of the plurality of channels 210, 220, 230, etc.) on which the service desired by the user of the receiving device (e.g. 110) is transmitted. The above holds also for the analog TV system.

The generic table format of the auxiliary data as used in both FIGS. 4A and 4B is just an example. However, various implementation of such logical representation are possible. Among others e.g. list, or linked list could be used to implement the auxiliary data.

In a preferred embodiment, the auxiliary data 340 comprises a language parameter 421. Availability of such parameter characterizing the service enables the receiving device 110 to act intelligently, which is discussed next.

In a preferred embodiment, the receiving device 110 is arranged to change automatically from a channel to a channel, these channels being a subset of a plurality of channels 210, 220, 230, etc. according to the auxiliary data 340, on which the desired services provided in the user pre-set language of the receiving device 110 are transmitted, and to receive these services provided in the user pre-set language.

The intelligence of the receiving device 110 enables an efficient changing/tuning to services possessing features desired by the user. Based on the auxiliary data 340, in this embodiment comprising the language information 421, services provided in the desired language can be selected, and subsequently these selected services can be acquired through focused changing/tuning to channels (subset of 210, 220, 230, etc.) indicated in the third column 430 or 435 of the auxiliary data table 340. The acquisition of the desired services is performed in an organized and focus manner instead of successive scanning of all channels 210, 220, 230, etc. in search for these services.

It is known that the user of the receiving device 110, e.g. TV or set-top box, can specify the language in which the communication between the device 110 and the user is to be performed. The language of the user choice is pre-set in the device 110. Therefore, the services in the language preferred by the user can be acquired without user interaction as this language information is already available in the device 110. This feature is especially interesting for users that live in the geographical regions where they are exposed to broadcast provided in different languages, e.g. near country borders. Instead of manually providing ZIP codes in order to determine services in the desired by the user language, the whole procedure can be automated.

In another preferred embodiment, the auxiliary data comprises a version number 422 of the service being transmitted. The availability of the version number information 422 corresponding to the services enables the receiving device to act intelligently.

For example, presence of version numbers 422 in the auxiliary data 340 makes selective updates of the services possible. In contemporary receiving devices (110, 120, 130, etc.) the service updates are performed at a time when the user is unlikely to use the receiving device, for example at night or at a time manually programmed by the user. This due to the fact that during the acquisition of the updates the receiving device 110 is blocked for a long period of time needed for acquiring all of the available services. Thanks to version number information 422, the user can select services to be updated, and consequently only these selected services can be updated in an ordered/focused manner using the channel information 430 or 435 conveyed in the auxiliary data 340. This way making the time during which the selective updates are performed significantly shorter than the nightly updates.

The user might also pre-select version numbers of updates that should in any case be retrieved, so that he will not be prompted for those updates every time. For example, if a major version number changes (e.g. the update is version 3.0 and currently installed is version 2.3), the user may desire that such update be automatically installed. He would then only be prompted for an upgrade from 2.3 to 2.4, but not for an upgrade from 2.3 to 3.0.

The user might also pre-select categories of updates, e.g. “critical”, “security”, “option”, “added feature”, “game” that should or should not be installed automatically.

FIG. 5 shows an example of an internal architecture of the receiving device 110. A first communication means 503 receives the auxiliary data 340. The auxiliary data 340 is communicated to a control means 504, in which the auxiliary data 340 is processed. Based on the user input or pre-set settings already available in the device 110 and the received auxiliary data 340, a control message is issued to a second communication means 501 and a decoding means 502. The second communication means 501 is responsible for listening/tuning to the channel, e.g. 210, indicated in the control message, and passing the received data to the decoding means 502. Based on the service selection comprised in the control message, the decoding means 502 searches the incoming data stream for portions of data corresponding to the selected service. These data portions when found are then processed by the decoding means 502 to provide the data in a format suitable for a device, for example, displaying the data or recording the data.

The displaying device (not shown) can be a separate device to the receiving device 110. As an example the receiving device 110 can be a set-top box, and the displaying device can be a TV set. Alternatively, the displaying device can be a part of the receiving device 110, e.g. a TV set in which the receiving device 110 is built in.

The second communication means 501, depicted in FIG. 5, comprises one tuner that enables listening/tuning to a specific channel (frequency). In case of multiple tuners present in the receiving device 110 the means 501 and 502 are duplicated for each of the tuners and are under control of the control means 504. The decoded services in excess to the service already displayed to the user can, for example, be recorded in the storage means. These storage means can be intern or extern to the receiving device 110.

The above description of the receiving device 110 is generic and applies to the digital and analog TV systems. However, in case of the analog TV systems the architecture can be simplified by removing the decoding means 502. This due to the following reasons:
in the analog TV systems only one service is transmitted on a channel;
no data coding is used for the services.

In case of digital TV systems, the decoding means 502 is essential for demultiplexing of the services. In other words, in pulling the services apart from a one-service data stream. To realize demultiplexing data portions belonging to different services are equipped in the labels/identifiers, which indicate to which service they belong. Furthermore, the decoding means 502 is essential for decoding of services. In the digital TV systems the data is created using digital data compression/encoding, e.g. MPEG-4 or MPEG-2, often in accordance with standards like DVB. Other compression/encoding formats are also possible. The decoding means 502 performs the reverse processing on the encoded service data to obtain the raw service data suitable for e.g. displaying or recording.

FIG. 6 shows an example of an internal architecture of a transmitting device 100. A first communication means 602 receives the data corresponding to services and passes it to a multiplexing means 603. A second communication means 604 receives the auxiliary data and passes it to the multiplexing means 603. The multiplexing means 603 is under control of a controlling means 601, which monitors the incoming service data and gathers the information about transmission (especially timing) requirements of each received service. Based on these service requirements the multiplexing means 603 mixes service data portions and auxiliary data portions into one data stream.

The above description of the transmitting device 100 is generic and applicable to the digital and analog TV systems. However, in case of the analog TV systems a few exceptions apply, as the service data in such systems is not encoded, there is no service information available, and only one service is transmitted on a channel. In the current analog TV systems any services such e.g. teletext or EPG are transmitted in blanking periods between video frames. Therefore, the multiplexing means 603 can insert the auxiliary data 340 in the blanking periods, which are not used yet by other services.

In the case of the digital TV, the multiplexing means 603 schedules the service data and the auxiliary data 340 so that the timing/transmission requirements of the services are guaranteed as well as a predetermined lowest frequency of the auxiliary data transmission is guaranteed as well.

The architecture of the transmitting device 100 as illustrated in FIG. 6 applies to a transmitting device 100 used in the data distribution system shown in FIG. 7.

FIG. 7 illustrates an alternative architecture of a data distribution system in which auxiliary data 340 is provided to a transmitting device from a separate device independent from a service data. A device 701 supplies the data corresponding to services. A device 702, independent of device 701, supplies the auxiliary data 340. Besides the auxiliary data the device 801 can also provide some of the services, such as e.g. TV guide, or others. The transmitting device 100 receives the data streams from the two sources 701 and 702, and combines them by means of multiplexing into one data stream, e.g. as shown in FIG. 2A or 2B, which data stream is transmitted to the receiving devices 110, 120, 130, etc.

FIG. 8 illustrates an alternative architecture of a data distribution system in which auxiliary data 340 is provided to a receiving device 110 from a separate device independent from a device 100 transmitting the service data. In the embodiment illustrated by this figure the auxiliary data is not multiplexed with the services, but distributed separately. The device 801 supplies the data corresponding to services to the transmitting device 100. The device 802 supplies the auxiliary data 340, and possibly some of the services. The device 802 transmits data directly to the receiving devices 110, 120, 130, etc. The transmission medium between the receiving devices 110, 120, 130, etc. and the device 802 can be of any form, e.g. fiber-coax, or telephone line.

It should be noted that the above-mentioned embodiments illustrate rather than limit the invention, and those skilled in the art will be able to design many alternative embodiments without departing from the scope of the appended claims. For instance instead of a display an audio output could be used.

In the accompanying claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer.

In the device claim enumerating several means, several of these means can be embodied by one and the same item of hardware. The mere fact that certain measures are recited in mutually different dependent claims does not indicate that a combination of these measures cannot be used to advantage.

1. A system for distribution of data comprising:
a transmitting device (100) arranged to transmit data comprising plurality of services, each service being transmitted on one of a plurality of channels (210, 220, 230, etc.);
a plurality of receiving devices (110, 120, 130, etc.) arranged to receive said data and to select a service from the plurality of services,
characterized by:
the receiving device (110) being arranged to receive auxiliary data (340) comprising information (310 and 320) about the service and an identification of one channel from said plurality of channels (330 or 335) on which said service is transmitted;
the receiving device (110) being arranged to change to the channel according to the auxiliary data (340) to receive the desired service corresponding to said channel.

2. A system as claimed in claim 1, wherein the auxiliary data (340) comprises language information (321) about the language in which said service being transmitted is provided.

3. A system as claimed in claim 2, wherein the receiving device (110) is arranged to change automatically to the channel, according to the auxiliary data (340), on which the desired services provided in the user pre-set language of the receiving device (110) are transmitted, and to receive said services provided in said user pre-set language.

4. A system as claimed in claim 1, wherein the auxiliary data (340) comprises a version number (322) of said service being transmitted.

5. The system as claimed in claim 1, wherein the data comprising the services and the auxiliary data (340) are comprised in a combined data.

6. A system as claimed in claim 1, wherein said auxiliary data (340) is provided to the transmitting device (100) from a separate device independent from the device providing the service data to the said transmitting device.

7. The system as claimed in claim 1, wherein the receiving device (110) is operable to receive the auxiliary data (340) from a separate device independent from the device (100) transmitting the service data.

8. A method of receiving distributed data comprising:
receiving data comprising a plurality of services, each service being transmitted on one of a plurality of channels (210, 220, 230, etc.);
selecting a service from said plurality of services;
receiving auxiliary data (340) comprising information (310 and 320) about the service and an identification of one channel (330 or 335) from said plurality of channels on which said service is transmitted;
changing to the selected channel (e.g. 210) according to the auxiliary data (340) to receive the desired service corresponding to said channel.

9. A receiving device (110) for receiving distributed data comprising:
means for receiving data comprising a plurality of services, each service being transmitted on one of a plurality of channels (210, 220, 230, etc.);
means for selecting a service from said plurality of services;
means for receiving auxiliary data (340) comprising information about the service (310 and 320) and an identification of one channel (330 or 335) from said plurality of channels (210, 220, 230, etc.) on which said service is transmitted; and
means for changing to the selected channel according to the auxiliary data (340) to receive the desired service corresponding to said channel.

10. A method of transmitting distributed data comprising:
transmitting data comprising plurality of services, each service being transmitted on one of a plurality of channels (210, 220, 230, etc.);
transmitting auxiliary data (340) comprising information (310 and 320) about the service and an identification of one channel from said plurality of channels (330 or 335) on which said service is transmitted.

11. A transmitting device (100) for transmitting distributed data comprising:
means for transmitting data comprising plurality of services, each service being transmitted on one of a plurality of channels (101, 102);
means for transmitting auxiliary data (340) comprising information (310 and 320) about the service and an identification of one channel from said plurality of channels (330 or 335) on which said service is transmitted.

12. A signal comprising data comprising services on a plurality of channels (210, 220, 230, etc.) and auxiliary data (340) comprising information about the services (310 and 320) and an identification of one or more service channels (330 or 335) from said plurality of channels (210, 220, 230, etc.) on which the services are transmitted, said auxiliary data (340) allowing a receiving device (110) to change to the selected channel to receive the corresponding service according to the auxiliary data (340).

13. A computer program product for causing a processor to operate as the receiving device (110) of claim 1.

14. A computer program product for causing a processor to operate as the transmitting device (100) of claim 1.
